(19) United States
(12) Patent Application Publication
(10) Pub. No.: US 2019/0233033 A1
(43) Pub. Date: Aug. 1, 2019

(54) SYSTEM AND METHOD FOR ADJUSTING A POSITION OF AN IDLER WHEEL OF A TRACK ASSEMBLY FOR A WORK VEHICLE

(71) Applicant: CNH Industrial America, LLC, New Holland, PA (US)

(72) Inventor: Travis L. Harnetiaux, Bourbonnais, IL (US)

(73) Assignee: CNH Industrial America, LLC

(21) Appl. No.: 15/884,465

(22) Filed: Jan. 31, 2018

(51) Int. Cl. B62D 55/30; B62D 11/00

(52) U.S. Cl. CPC B62D 55/30; B62D 11/003

(57) ABSTRACT

In one aspect, a system for adjusting a position of an idler wheel of a track assembly for a work vehicle relative to the ground may include a track assembly having a first idler wheel. The system may also include a first actuator configured to move the first idler wheel between a lowered position relative to the ground and a raised position relative to the ground. Furthermore, the system may include a controller communicatively coupled to the first actuator. The controller may be configured to receive inputs indicative of an anticipated or actual change in a direction of travel of the work vehicle. The controller may further be configured to control the first actuator to move the first idler wheel from the lowered position to the raised position in response to determining that the work vehicle has initiated a change in the direction of travel.

### FIELD

The present disclosure generally relates to work vehicles and, more particularly, to systems and methods for adjusting a position of an idler wheel of a track assembly for a work vehicle relative to the ground when the work vehicle is initiating a turn.

### BACKGROUND

Current work vehicles, such as tractors and other agricultural vehicles, include an electronically controlled engine and a transmission, such as a power shift transmission (PST) or a continuously variable transmission (CVT), coupled to the engine. The transmission is, in turn, coupled to at least one drive axle assembly for transferring torque from the transmission to the vehicle's wheels or tracks. For instance, for a four-wheel drive track-driven vehicle, a drive wheel of each front track assembly is typically rotationally coupled to a front axle assembly of the work vehicle for transferring torque transmitted from the engine to each front track assembly. Similarly, a drive wheel of each rear track assembly is typically rotationally coupled to a rear axle assembly of the work vehicle for transferring torque transmitted from the engine to each rear track assembly. As is generally understood, each drive wheel may be configured to rotationally engage a corresponding endless track of the associated track assembly such that rotation of the drive wheel rotates the track, thereby allowing the vehicle to be driven forward or backward.

In addition to the drive wheel, each track assembly may include a various other track wheels configured to engage the track, such as a pair of idler wheels and a plurality of roller wheels. More specifically, the idler wheels are configured to apply an outward force on the associated track, thereby providing sufficient tension within the track such that the track remains engaged with the associated drive wheel. As such, one of the idler wheels is positioned at a forward end of the track assembly, while the other of the idler wheels is positioned at an aft end of the track assembly. Furthermore, the roller wheels are generally positioned between the idler wheels so as to support the portion of the track located between the idler wheels.

In general, the idler wheels are positioned above the roller wheels relative to the ground such that the portions of the track engaging the idler wheels are raised off of the ground. This configuration allows the work vehicle to turn or otherwise change its direction of travel without creating berms in the soil or scuffing the tracks. However, such configuration requires that the roller wheels support substantially all of the weight of the work vehicle relative to the associated track assembly. As such, a large amount of heat is generated within the roller wheels, thereby limiting the maximum speed and maximum load carrying capacity at which the work vehicle may travel.

Accordingly, an improved system and method for adjusting a position of the idler wheel(s) of a track assembly for a work vehicle relative to the ground when the work vehicle is initiating a turn to increase the maximum load carrying capacity and/or the maximum speed of the work vehicle would be welcomed in the technology.

### BRIEF DESCRIPTION

Aspects and advantages of the technology will be set forth in part in the following description, or may be obvious from the description, or may be learned through practice of the technology.

In one aspect, the present subject matter is directed to a system for adjusting a position of an idler wheel of a track assembly for a work vehicle relative to the ground. The system may include a track assembly having a track and a first idler wheel configured to apply an outward pressure on the track. The system may also include a first actuator configured to move the first idler wheel between a lowered position relative to the ground and a raised position relative to the ground. Furthermore, the system may include a controller communicatively coupled to the first actuator. The controller may be configured to receive inputs indicative of an anticipated or actual turn or change in a direction of travel of the work vehicle. The controller may further be configured to control the first actuator to move the first idler wheel from the lowered position to the raised position in response to determining that the work vehicle has initiated a turn.

In one aspect, the present disclosure is directed to a method for adjusting a position of an idler wheel of a track assembly for a work vehicle relative to the ground. The track assembly may include a first idler wheel. The method may include controlling, with a computing device, an operation of a first actuator such that the first idler wheel is disposed at a lowered position relative to the ground. The method may also include determining, with the computing device, when the work vehicle has initiated a change in a direction of travel based on one or more inputs received from an input device. Furthermore, the method may include controlling, with the computing device, the operation of the first actuator to move the first idler wheel from the lowered position to a raised position relative to the ground in response to determining that the work vehicle has initiated the change in the direction of travel.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of a work vehicle in accordance with aspects of the present subject matter;

FIG. 2 illustrates a perspective view of one embodiment of a track assembly suitable for use within the work vehicle shown in FIG. 1 in accordance with aspects of the present subject matter;

FIG. 3 illustrates a schematic view of one embodiment of a system for adjusting a position of an idler wheel of a track assembly for a work vehicle in accordance with aspects of the present subject matter, particularly illustrating the system including a sensor provided in operative association with a control device of the work vehicle;

FIG. 4 illustrates a schematic view of another embodiment of a system for adjusting a position of an idler wheel of a track assembly for a work vehicle in accordance with aspects of the present subject matter, particularly illustrating the system including a location sensor;

FIG. 5 illustrates a schematic view of another embodiment of a system for adjusting a position of an idler wheel of a track assembly for a work vehicle in accordance with aspects of the present subject matter, particularly illustrating the system including a user input device for receiving notifications from a operator of the work vehicle;

FIG. 6 illustrates a partial side of the track assembly shown in FIG. 2, particularly illustrating the idler wheels of the track assembly positioned at a lowered position relative to the ground;

FIG. 7 illustrates a partial side of the track assembly shown in FIG. 2, particularly illustrating the idler wheels of the track assembly positioned at a raised position relative to the ground; and

FIG. 8 illustrates a flow chart of one embodiment of a method for adjusting a position of an idler wheel of a track assembly for a work vehicle in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and method for adjusting a position of an idler wheel of a track assembly for a work vehicle relative to the ground. Specifically, in several embodiments, a controller of the disclosed system may be configured to determine when the work vehicle has initiated a turn or a change in its direction of travel based on an input(s) received from a suitable input device(s). For example, in one embodiment, the input may correspond to measurement signals received from a sensor provided in operative association with a control device of the work vehicle, such as a steering wheel. After determining that the work vehicle has initiated a turn, the controller may be configured to control an operation of an actuator coupled to the idler wheel so as to move the idler wheel from a lowered position relative to the ground to a raised position relative to the ground.

In accordance with aspects of the present disclosure, the idler wheel may be positioned at the lowered position when the work vehicle is traveling in a generally constant direction and at the raised position when the work is changing its direction of travel. In several embodiments, when the idler wheel is at the lowered position, a portion of the track of the track assembly engaging the idler wheel may be in contact with the ground. As such, the idler wheel may be able to partially support the weight of the work vehicle relative to the track assembly when the work vehicle is traveling in a generally constant direction, thereby reducing the heat generated within roller wheels of the track assembly. Furthermore, when the idler wheel is at the raised position, the portion of the track engaging the idler wheel is lifted off of the ground. In this regard, the track does not scuff or create berms in the soil when the work vehicle is turning.

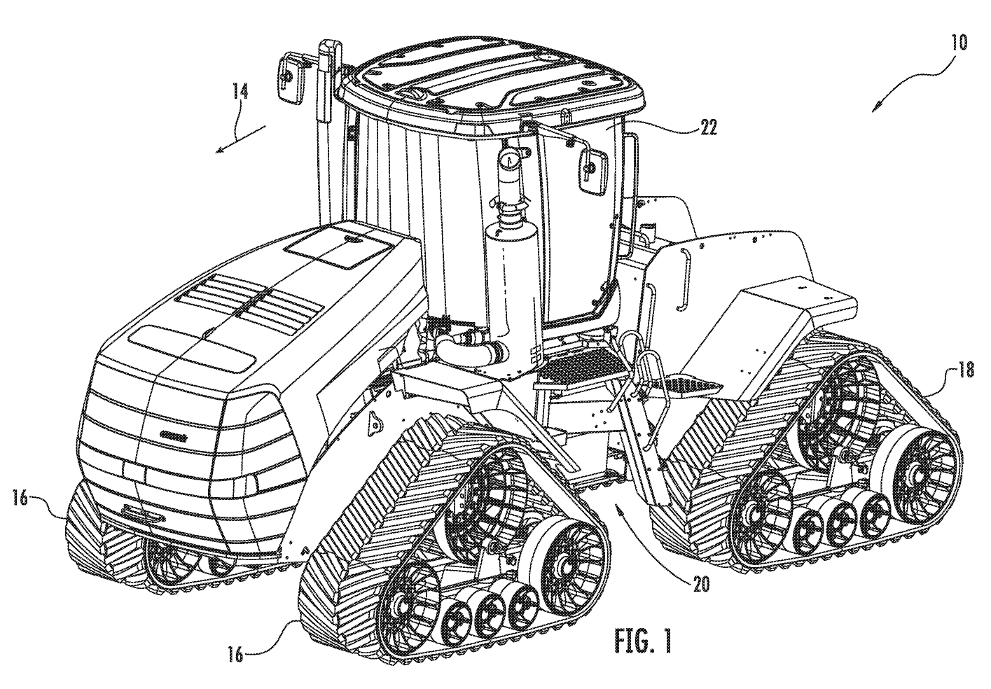

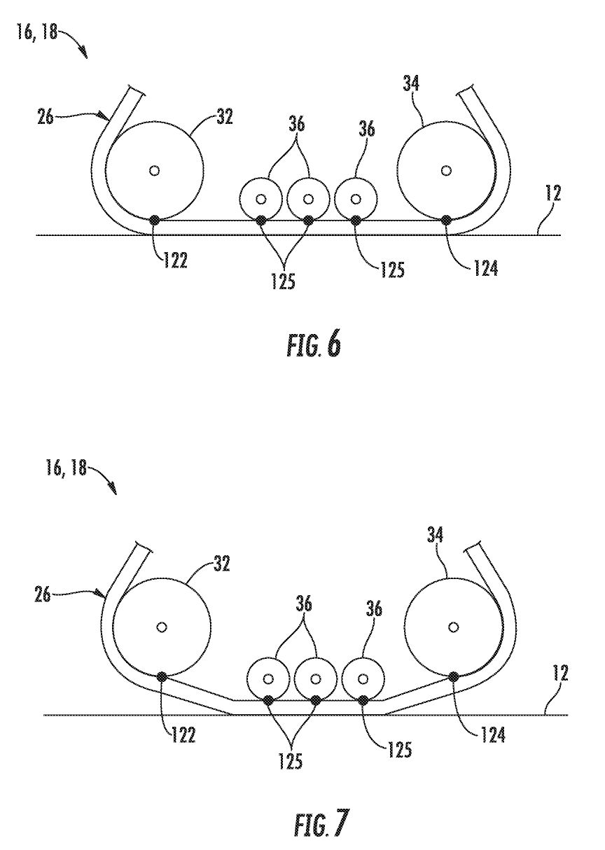

Referring now to the drawings, FIG. 1 illustrates a perspective view of one embodiment of a work vehicle 10. In general, the work vehicle 10 may be configured to traverse a ground surface 12 (FIG. 6) or otherwise move in a direction of travel 14. As shown, the work vehicle 10 is configured as an agricultural tractor. However, in other embodiments, the work vehicle 10 may be configured as any other suitable work vehicle known in the art, including those for agricultural and construction applications, transport, sport, and/or the like.

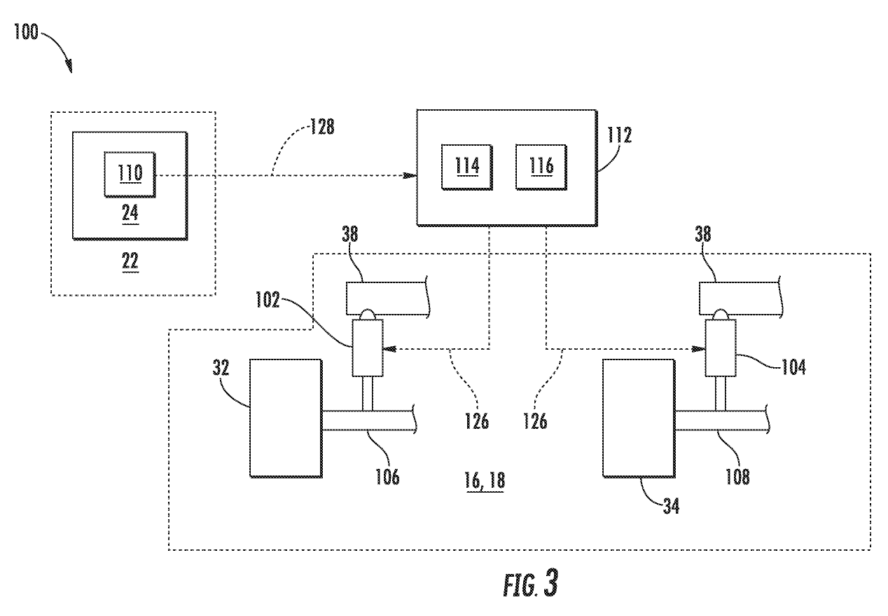

As shown in FIG. 1, the work vehicle 10 includes a pair of front track assemblies 16, a pair or rear track assemblies 18 (only one of which is shown), and a chassis 20 coupled to and supported by the track assemblies 16, 18. Additionally, an enclosed operator's cab 22 is supported by a portion of the chassis 20 and may house various control devices 24 (FIG. 3), such as a steering wheel, levers, and/or the like, for permitting an operator to control the operation of the work vehicle 10.

It should be appreciated that the configuration of the work vehicle 10 described above and shown in FIG. 1 is provided only to place the present subject matter in an exemplary field of use. Thus, it should be apparent that the present subject matter may be readily adaptable to any manner of work vehicle configuration. For example, in an alternative embodiment, the work vehicle 10 may include an open operator's cab 22 and/or may be configured to be operably coupled to any suitable type of work implement, such as a trailer, spray boom, manure tank, feed grinder, plow, and/or the like.

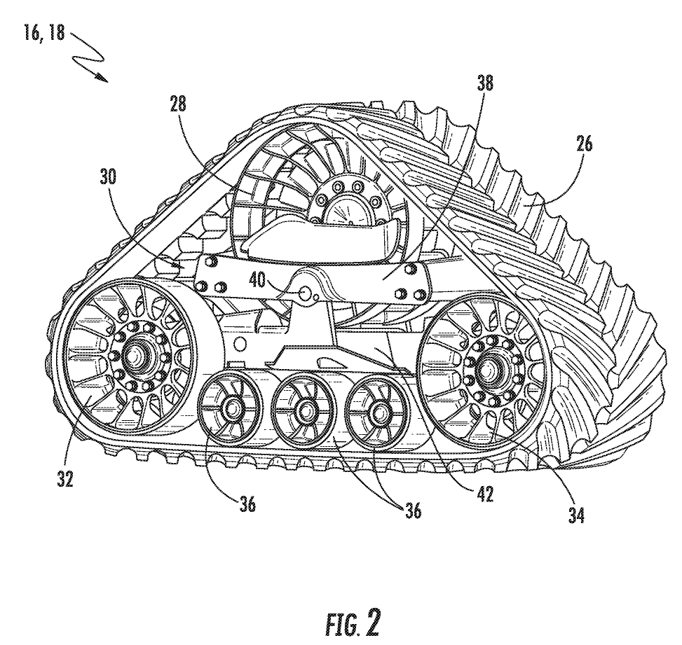

Referring now to FIG. 2, a perspective view of an exemplary embodiment of one of the track assemblies 16, 18 shown in FIG. 1 is illustrated in accordance with aspects of the present subject matter. As shown, the track assembly 16, 18 may generally include a track 26, a drive wheel 28 for mechanically engaging and rotationally driving the track 26, and a suspension system 30 for supporting the weight of the work vehicle 10 and for damping vibrations and other movement between the track 26 and the vehicle's chassis 20. In one embodiment, the suspension system 30 may include front and rear idler wheels 32, 34 about which the track 26 is wrapped and a plurality of roller wheels 36 for guiding the track 26 between the idler wheels 32, 34. Additionally, the suspension system 30 may include an undercarriage support beam 38 configured to support the idler wheels 32, 34 and the roller wheels 36 relative to the track 26. For example, as shown in FIG. 2, the undercarriage support beam 38 may extend fore-to-aft within the track assembly 16, 18 to allow the various wheels 32, 34, 36 to be coupled thereto and/or supported thereby.

As is generally understood, the undercarriage support beam 38 may be pivotally supported on the vehicle chassis 20 (FIG. 1) by two pivot pins, namely an outboard pivot pin 40 and an inboard pivot pin (not shown). The outboard pivot pin 40 is located outboard of the drive wheel 28, while the inboard pivot pin is located inboard of the drive wheel 28 and is secured on the vehicle chassis 20. In general, the outboard pivot pin 40 may be configured to be coupled between an undercarriage bearing support member 42 and the undercarriage support beam 38. For example, the pivot pin 40 may be configured to be received within both an opening (not shown) defined through the bearing support member 42 and a corresponding outboard opening (not shown) defined in the support beam 38. The bearing support member 42 may, in turn, be secured at each of its ends to support posts (not shown) coupled to the vehicle chassis 20. As such, the outboard pivot pin 40 may serve to pivotally couple the undercarriage support beam 38 to the chassis 20.

It should be appreciated that a similar pivotal support arrangement may also be provided on the vehicle chassis 20 inboard of the drive wheel 28 utilizing the inboard pivot pin. For example, the inboard pivot pin may be configured to be received within a suitable opening (not shown) defined in the undercarriage support beam 38 for pivotally coupling the support beam 38 to the chassis 20.

It should also be appreciated that the track assembly 16, 18 shown in FIG. 2 is simply illustrated to provide one example of a suitable track assembly configuration. In other embodiments, the track assembly 16, 18 may have any other suitable track-based configuration.

Referring now to FIG. 3, a perspective view of one embodiment of a system 100 for adjusting a position of an idler wheel of a track assembly for a work vehicle is illustrated in accordance with aspects of the present subject matter. In general, the system 100 will be described herein with reference to the work vehicle 10 shown in FIG. 1 and the embodiment of the track assembly 16, 18 described above with reference to FIGS. 1-2. However, it should be appreciated by those of ordinary skill in the art that the disclosed system 100 may generally be utilized with track assemblies having any other suitable track assembly configuration and/or work vehicles having any other suitable vehicle configuration.

As shown in FIG. 3, in several embodiments, the system 100 may a front actuator 102 and a rear actuator 104. In general, the front and rear actuators 102, 104 may be configured to respectively move the idler wheels 32, 34 relative to the support beam 38 of the track assembly 16, 18. As will be described below, adjusting the position of the idler wheels 32, 34 relative to the support beam 38 may raise and/or lower the idler wheels 32, 34 relative to the ground surface 12 (FIG. 6). For example, as shown, in one embodiment, one end of the front actuator 102 may be coupled to the support beam 38, while an opposed end of the front actuator 102 may be coupled to an axle 106 of the front idler wheel 32. Similarly, one end of the rear actuator 104 may be coupled to the support beam 38, while an opposed end of the rear actuator 104 may be coupled to an axle 108 of the rear idler wheel 34. However, a person of ordinary skill in the art would appreciate that the actuators 102, 104 may be coupled between the idler wheels 32, 34 and the support beam 38 in any suitable manner that permits the actuators 102, 104 to move the idler wheels 32, 34 relative to the support beam 38. For example, suitable linkages (not shown) may be coupled between the support beam 38 and the corresponding ends of the actuators 102, 104 and/or between the axles 106, 108 and the corresponding ends of the actuators 102, 104.

It should be appreciated that the actuators 102, 104 may generally correspond to any suitable actuators known in the art. For example, as illustrated in FIG. 3, in one embodiment, the actuators 102, 104 may correspond to electric linear actuators. However, in alternative embodiments, the actuators 102, 104 may correspond to hydraulic actuators, pneumatic actuators, or electric rotary actuators, and/or the like.

The system 100 may also include the one or more control devices 24 of the work vehicle 10. In general, the control device(s) 24 may generally be configured to control various aspects of the work vehicle 10, such as the direction of travel 14 of the work vehicle 10 or a speed at which the work vehicle 10 moves in the direction of travel 14. For example, in one embodiment, the control device(s) 24 may include a steering wheel (not shown) with which an operator of the work vehicle 10 is able to turn or otherwise change the direction of travel 14 of the work vehicle 10. In another embodiment, the control device(s) 24 may include one or more levers (not shown) with which an operator of the work vehicle 10 is able to turn the work vehicle 10. However, it should be appreciated that the control device(s) 24 may include or correspond to any other suitable devices with which the operator is able to turn the work vehicle 10 or otherwise control the movement of the work vehicle 10. Additionally, as indicated above, such control device(s) 24 may be located within the operator's cab 22 of the work vehicle 10.

Furthermore, in several embodiments, the system 100 may include a sensor 110 provided in operative association with the control device(s) 24. In general, the sensor 110 may be configured to detect a parameter associated with direction of travel 14 of the work vehicle 10 or turn or a change in the direction of travel 14 of the work vehicle 10. For example, in embodiments where the control device(s) 24 includes or corresponds to a steering wheel, the sensor 110 may be provided in operative association with the steering wheel so as to detect the current steering angle associated with the steering wheel (e.g., as controlled by the operator). In general, the steering angle may be indicative of the direction of travel 14 of the work vehicle 10 and/or a turn by the work vehicle 10. In such embodiments, the sensor 110 may, for example, correspond to a rotary potentiometer or any other suitable sensor for detecting rotational position and/or rotational movement. It should be appreciated, however, that the sensor 110 may be provided in operative association with any other suitable control device(s) 24. Furthermore, the sensor 110 may correspond to any other suitable type of sensor and/or may be configured to detect any other suitable parameter associated with the direction of travel 14 of the work vehicle 10 or a turn by the work vehicle 10.

In accordance with aspects of the present disclosure, the system 100 may further include a controller 112 configured to electronically control the operation of one or more components of the work vehicle 10. In general, the controller 112 may comprise any suitable processor-based device known in the art, such as a computing device or any suitable combination of computing devices. Thus, in several embodiments, the controller 112 may include one or more processor(s) 114 and associated memory device(s) 116 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 116 of the controller 112 may generally comprise memory element(s) including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 116 may generally be configured to store suitable computer-readable instructions that, when implemented by the processor(s) 114, configure the controller 112 to perform various computer-implemented functions, such as one or more aspects of the methods 200 described below with reference to FIG. 8. In addition, the controller 112 may also include various other suitable components, such as a communications circuit or module, one or more input/output channels, a data/control bus and/or the like.

It should be appreciated that the controller 112 may correspond to an existing controller of the work vehicle 10 or the controller 112 may correspond to a separate processing device. For instance, in one embodiment, the controller 112 may form all or part of a separate plug-in module that may be installed within the work vehicle 10 to allow for the disclosed system and method to be implemented without requiring additional software to be uploaded onto existing control devices of the work vehicle 10.

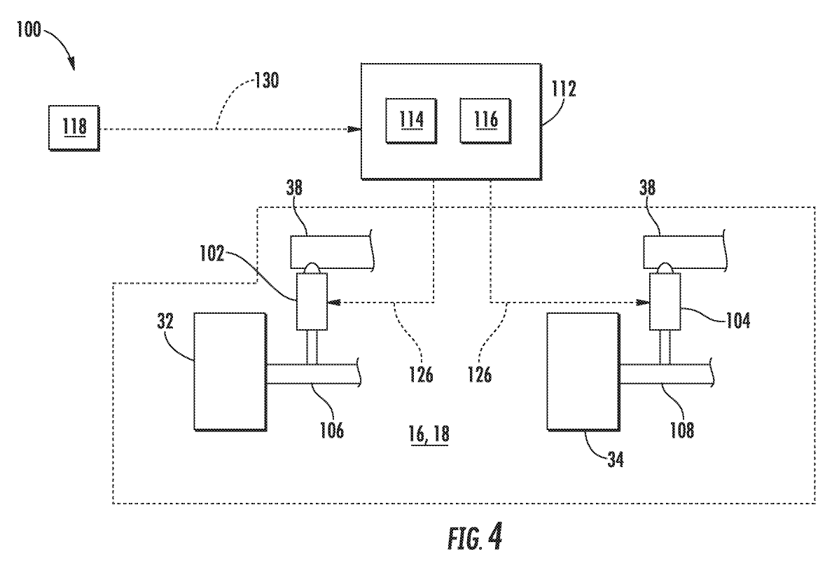

Referring now to FIG. 4, a schematic view of another embodiment of the system 100 described above with reference to FIG. 3 is illustrated in accordance with aspects of the present subject matter. As shown, the system 100 may generally be configured the same as or similar to that described above with reference to FIG. 3. For instance, the system 100 may include the first and second actuators 102, 104 and the controller 112, with the first and second actuators 102, 104 being configured to respectively move the idler wheels 32, 34 relative to the support 38. However, as shown in FIG. 4, unlike the above-described embodiment, the system 100 may include a location sensor 118 in addition to or in place of the sensor 110. In general, the location sensor 118 may be configured to detect a parameter associated with a location of the work vehicle 10, such as GPS coordinates. As will be described below, the detected location of the work vehicle 10 may be associated with the direction of travel 14 of the work vehicle 10 or a turn by the work vehicle 10. It should be appreciated that the location sensor 118 may correspond to a GPS receiver or any other suitable location sensor.

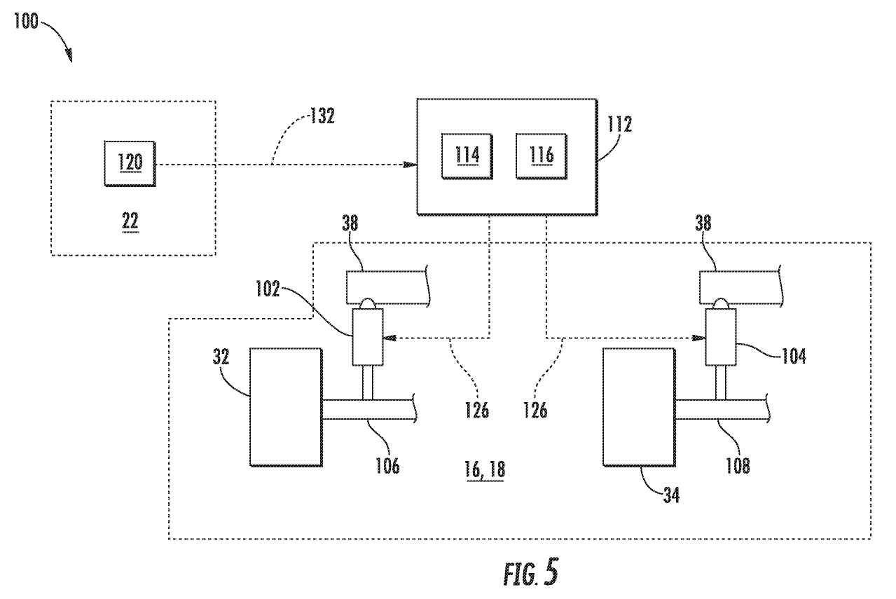

Referring now to FIG. 5, a schematic view of a further embodiment of the system 100 described above with reference to FIGS. 3 and 4 is illustrated in accordance with aspects of the present subject matter. As shown, the system 100 may generally be configured the same as or similar to that described above with reference to FIGS. 3 and 4. For instance, the system 100 may include the first and second actuators 102, 104 and the controller 112, with the first and second actuators 102, 104 being configured to respectively move the idler wheels 32, 34 relative to the support 38. However, as shown in FIG. 5, unlike the above-described embodiments, the system 100 may include one or more user input device(s) 120 in place of or in addition to the sensor 110 or the location sensor 118. In general, the user input device(s) 120 may be configured to receive a notification from the operator of the work vehicle 10 associated with the direction of travel 14 of the work vehicle 10 or a turn by the work vehicle 10. As such, the user input device(s) 120 may correspond to one or more touchscreens, keypads, touchpads, knobs, buttons, sliders, switches, mice, microphones, and/or the like, which are configured to receive notifications from the operator. For example, in one embodiment, the operator may provide a first notification to the user input device(s) 120 (e.g., by pressing a button) when initiating a turn with the work vehicle 10 and a second notification to the user input device(s) 120 (e.g., by pressing the button again) when the turn is complete. In this regard, such user input device(s) 120 may be located within the operator's cab 22 of the work vehicle 10.

It should be appreciated that the user input device(s) 120 are generally different than the control device(s) 24. For example, in several embodiments, the control device(s) 24 may be used by the operator of the work vehicle 10 to control the direction of travel 14 of the work 10. As such, the operator of the work vehicle 10 may use the control device(s) 24 to initiate and/or terminate a turn by the work vehicle 10. Conversely, the user input device(s) 120 may be used by the operator of the work vehicle to provide a notification of a turn by the work vehicle 10, such as when the sensors 110, 118 are not present to detect turns. In this regard, in some embodiments, the user input device(s) 120 may generally not be configured to control the direction of travel 14 of the work vehicle 10.

Furthermore, it should be appreciated that embodiments of the system 100 may include any or all of the sensor 110, the location sensor 118, and/or the user input device(s) 120. Additionally, in some embodiments, the system 100 may include other sensor(s)/input device(s) in addition to or in lieu of the sensor 110, the location sensor 118, and/or the user input device(s) 120.

Referring now to FIG. 6, in several embodiments, the idler wheels 32, 34 may be positioned at a lowered position relative to the ground surface 12 when the work vehicle 10 is traveling in a constant or substantially constant direction of travel 14. More specifically, as indicted above, the idler wheels 32, 34 may be configured to engage the track 26 so as to apply an outward force on the track 26, thereby providing sufficient tension within the track 26 such that the track 26 remains engaged with the drive wheel 28 (FIG. 2). In this regard, as shown, a bottommost portion 122 of the front idler wheel 32 may engage a portion of the track 26, and a bottommost portion 124 of the rear idler wheel 34 may engage a portion of the track 26. In general, when the idler wheels 32, 34 are at the lowered position, the portions of the track 26 that engage the bottommost portions 122, 124 of the idler wheels 32, 34 may be contact with the ground surface 12. Furthermore, the roller wheels 36 may also be positioned at the lowered position relative to the ground surface 12. As such, the bottommost portions 122, 124 of the idler wheels 32, 34 may generally be positioned at the same height relative to the ground surface 12 as bottommost portions 125 of the roller wheels 36 when the idler wheels 32, 34 are disposed at the lowered position. Accordingly, the idler wheels 32, 34 may able to support a portion of the weight of the work vehicle 10 relative to the track 26 when positioned at the lowered position.

In one embodiment, when the work vehicle 10 is traveling in a constant or substantially constant direction of travel, the controller 112 may be configured to control the operation of the actuators 102, 104 such that the idler wheels 32, 34 are positioned at the lowered position relative to the ground surface 12. Specifically, as illustrated in FIGS. 3-5, the controller 112 may be communicatively coupled to the actuators 102, 104 via a wired or wireless connection to allow control signals (e.g., indicated by dashed lines 126 in FIGS. 3-5) to be transmitted from the controller 112 to the actuators 102, 104. For example, the control signals 126 may be configured to instruct the actuators 102, 104 to extend or retract so as to respectively move the idler wheels 32, 34 relative to the support beam 38 such that the idler wheels 32, 34 are positioned at the lowered position. However, it should be appreciated that, in alternative embodiments, the actuators 102, 104 may be controlled in any other suitable manner such that the actuators 102, 104 respectively position the idler wheels 32, 34 at the lowered position.

In accordance with aspects of the present subject matter, the controller 112 may also be configured to receive an input indicative of the initiation of turn by the work vehicle 10. For example, as shown in FIG. 3, in one embodiment, the controller 112 may be communicatively coupled to the sensor 110 via a wired or wireless connection to allow measurement signals (e.g., indicated by dashed line 128 in FIG. 3) to be transmitted from the sensor 110 to the controller 112. In general, the measurement signals 128 may be associated with the current direction of travel 14 of the work vehicle 10, such as a current angle or position of the control device(s) 24 (e.g., the steering wheel) of the work vehicle 10. As such, the controller 112 may be configured determine the current direction of travel 14 of the work vehicle 10 based on the measurement signals 128 received from the sensor 110. For instance, the controller 112 may include a look-up table or suitable mathematical formula stored within its memory 116 that correlates the sensor measurements to the current direction of travel 14 of the work vehicle 10. The controller 112 may then be configured to compare the current direction of travel 14 of the work vehicle 10 and a previous direction of travel 14 to determine when a turn by the work vehicle 10 has been initiated.

In another embodiment, as shown in FIG. 4, the controller 112 may be configured to receive an input indicative of the initiation of a turn from the location sensor 118. Specifically, the controller 112 may be communicatively coupled to the location sensor 118 via a wired or wireless connection to allow location signals (e.g., indicated by dashed line 130 in FIG. 4) to be transmitted from the location sensor 118 to the controller 112. In general, the location signals 130 may be indicative of a location of the work vehicle 10 (e.g., global positioning system coordinates). In such embodiments, the controller 112 may be configured to determine the position of the work vehicle 10 within the field based on those location signals 130. For example, the controller 112 may be configured to compare this determined location to a map stored within its memory 116 so as to determine the location of the work vehicle 10 within the field. When the controller 112 determines that the work vehicle 10 is proximate to an edge of the field (e.g., an end of a row within the field), the controller 112 may be configured determine that a turn by the work vehicle 10 has been initiated or will be initiated shortly.

In a further embodiment, as shown in FIG. 5, the controller 112 may be configured to receive an input indicative of the initiation of a turn from the user input device(s) 120. Specifically, the controller 112 may be communicatively coupled to the user input device(s) 120 via a wired or wireless connection to allow user input signals (e.g., indicated by dashed line 132 in FIG. 5) to be transmitted from the user input device(s) 120 to the controller 112. In general, the user input signals 132 may be notifications from the operator of the work vehicle 10 that the work vehicle 10 has initiated a turn. However, it should be appreciated that, in alternative embodiments, the controller 112 may be configured to receive any other suitable input indicative an initiation of a turn by the work vehicle 10 from any other suitable source.

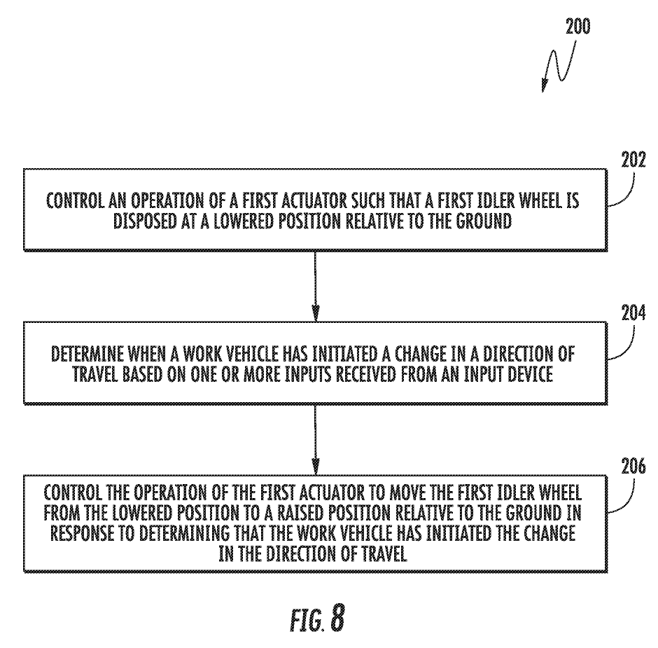

Moreover, once the controller 112 has determined that the work vehicle 10 has initiated a turn, the controller 112 may be configured to control the operation of the actuators 102, 104 such that the idler wheels 32, 34 are moved from the lowered position to a raised position relative to the ground surface 12. In general, as shown in FIG. 7, when the idler wheels 32, 34 are at the raised position, the portions the track 26 that respectively engage the bottommost portions 122, 125 of the idler wheels 32, 34 may be lifted off of the ground surface 12. As such, the work vehicle 10 is able to turn without forming berms or scuffing the tracks 26.

In several embodiments, when the work vehicle 10 has initiated a turn, the controller 112 may be configured transmit the control signals 126 to the actuators 102, 104 to control their operation. For example, the control signals 126 may be configured to instruct the actuators 102, 104 to extend or retract so as to respectively move the idler wheels 32, 34 relative to the support beam 38 such that the idler wheels 32, 34 are positioned at the raised position. In one embodiment, the controller 112 may be configured to control the actuators 102, 104 such that both of the idler wheels 32, 34 are moved from the lowered position to the raised position simultaneously. However, it should be appreciated that, in alternative embodiments, the actuators 102, 104 may be controlled in any other suitable manner such that the actuators 102, 104 respectively move the idler wheels 32, 34 moved from the lowered position to the raised position.

Furthermore, the controller 112 may also be configured to receive one or more inputs indicative of the completion of the turn by the work vehicle 10. For example, as described above, in one embodiment, the controller 112 may be configured determine the current direction of travel 14 of the work vehicle 10 based on the measurement signals 128 received from the sensor 110. In this regard, the controller 112 may then be configured to compare the current direction of travel 14 of the work vehicle 10 and a previous direction of travel 14 to determine when the turn by the work vehicle 10 has been completed. In another embodiment, as described above, the controller 112 may be configured to determine the position of the work vehicle 10 within the field based on the location signals 130 received from the location sensor 118. As such, when the controller 112 determines that the work vehicle 10 is moving away from the edge of the field (e.g., has started a row in the field), the controller 112 may be configured determine that the turn by the work vehicle 10 has been completed or will be completed shortly. In a further embodiment, the controller 112 may be configured to receive input from the user input device(s) 120 indicative of the completion of a given turn. In such an embodiment, the user input signals 132 from the user input device(s) 120 may be notifications from the operator of the work vehicle 10 that the work vehicle 10 has completed a turn. However, it should be appreciated that, in alternative embodiments, the controller 112 may be configured to receive any other suitable input indicative of the completion of a turn by the work vehicle 10 from any other suitable source.

Moreover, when the controller 112 has determined that the work vehicle 10 has completed the turn, the controller 112 may be configured to control the operation of the actuators 102, 104 such that the idler wheels 32, 34 are moved from the raised position back to the lowered position. For example, in several embodiments, the controller 112 may be configured transmit the control signals 126 to the actuators 102, 104 instructing the actuators 102, 104 to extend or retract so as to respectively move the idler wheels 32, 34 relative to the support beam 38 such that the idler wheels 32, 34 are positioned at the lowered position. In one embodiment, the controller 112 may be configured to control the actuators 102, 104 such that both of the idler wheels 32, 34 are moved from the raised position to the lowered position simultaneously. As described above and shown in FIG. 6, when the idler wheels 32, 34 are at the lowered position, the portions of the track 26 that respectively engage the bottommost portions 122, 124 of the idler wheels 32, 34 may be contact with the ground surface 12 such that the idler wheels 32, 34 are able to support a portion of the weight of the work vehicle 10 relative to the track 26.

Referring now to FIG. 8, a flow diagram of one embodiment of a method 200 for adjusting a position of an idler wheel of a track assembly for a work vehicle relative to the ground is illustrated in accordance with aspects of the present subject matter. In general, the method 200 will be described herein with reference to the work vehicle 10; the track assembly 16, 18; and the system 100 described above with reference to FIGS. 1-7. However, it should be appreciated by those of ordinary skill in the art that the disclosed method 200 may generally be utilized to adjust the position of an idler wheel of a track assembly for any work vehicle having any suitable vehicle configuration, of any track assembly having any suitable track assembly configuration, and/or of any system having any suitable system configuration. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 8, at (202), the method 200 may include controlling an operation of a first actuator such that a first idler wheel is disposed at a lowered position relative to the ground. For instance, as described above, when the work vehicle 10 is traveling in a constant or substantially constant direction of travel, the controller 112 may be configured to control the operation of the actuators 102, 104 such that the idler wheels 32, 34 are positioned at the lowered position relative to the ground surface 12.

Additionally, at (204), the method 200 may include determining when a work vehicle has initiated a change in a direction of travel based on one or more inputs received from an input device. For instance, as described above, the controller 112 may be configured to determine when work vehicle 10 has initiated a turn based on the measurement signals 128 received from the sensor 110, the location signals 130 received from the location sensor 118, and/or the user input signals 132 received from the user input device(s) 120.

Moreover, as shown in FIG. 8, at (206), the method 200 may include controlling the operation of the first actuator to move the first idler wheel from the lowered position to a raised position relative to the ground in response to determining that the work vehicle has initiated the change in the direction of travel. For instance, as described above, when the work vehicle 10 has initiated a turn, the controller 112 may be configured to control the operation of the actuators 102, 104 such that the idler wheels 32, 34 are moved from the lowered position to the raised position relative to the ground surface 12.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for adjusting a position of an idler wheel of a track assembly for a work vehicle relative to the ground, the system comprising:
a track assembly including a track and a first idler wheel configured to apply an outward pressure on the track;
a first actuator configured to move the first idler wheel between a lowered position relative to the ground and a raised position relative to the ground; and
a controller communicatively coupled to the first actuator, the controller being configured to receive inputs indicative of an anticipated or actual change in a direction of travel of the work vehicle, the controller further being configured to control the first actuator to move the first idler wheel from the lowered position to the raised position in response to determining that the work vehicle has initiated a change in the direction of travel.

2. The system of claim 1, wherein the controller is further configured to:
determine when the work vehicle has completed the change in the direction of travel based on the received inputs; and
control the first actuator to move the first idler wheel from the raised position to the lowered position upon determining that the work vehicle has completed the change in the direction of travel.

3. The system of claim 1, wherein the inputs are received by the controller from a sensor provided in operative association with a control device of the work vehicle, the control device being configured to initiate the change in the direction of travel of the work vehicle, the sensor being configured to detect a parameter indicative of the initiation of the change in the direction of travel by the control device.

4. The system of claim 1, wherein the inputs are received by the controller from a location sensor configured to detect a parameter associated with a location of the work vehicle.

5. The system of claim 1, wherein inputs are received from the controller from an operator-controlled input device of the work vehicle.

6. The system of claim 1, wherein the track assembly further comprises a plurality of roller wheels positioned at the lowered position relative to the ground.

7. The system of claim 1, wherein the track assembly further comprising a second idler wheel configured to apply an outward pressure on the track, the system further comprising:
a second actuator configured to move the second idler wheel between the lowered position relative to the ground and the raised position relative to the ground, the controller being communicatively coupled to the second actuator, the controller further being configured to control the first and second actuators to move the first and second idler wheels simultaneously from the lowered position to the raised position when it is determined that the work vehicle has initiated the change in the direction of travel.

8. The system of claim 1, wherein the first actuator corresponds to an electric actuator.

9. A method for adjusting a position of an idler wheel of a track assembly for a work vehicle relative to the ground, the track assembly including a first idler wheel, the method comprising:
controlling, with a computing device, an operation of a first actuator such that the first idler wheel is disposed at a lowered position relative to the ground;
determining, with the computing device, when the work vehicle has initiated a change in a direction of travel based on one or more inputs received from an input device; and
controlling, with the computing device, the operation of the first actuator to move the first idler wheel from the lowered position to a raised position relative to the ground in response to determining that the work vehicle has initiated the change in the direction of travel.

10. The method of claim 9, further comprising:
determining, with a computing device, when the work vehicle has completed the change in the direction of travel based on the one or more inputs; and
controlling, with the computing device, the first actuator to move the first idler wheel from the raised position to the lowered position upon determining that the work vehicle has completed the change in the direction of travel.

11. The method of claim 9, further comprising:
receiving, with the computing device, the one or more inputs from a sensor provided in operative association with a control device of the work vehicle, the control device being configured to initiate the change in the direction of travel of the work vehicle, the sensor being configured to detect a parameter indicative of the initiation of the change in the direction of travel by the control device.

12. The method of claim 9, further comprising:
receiving, with the computing device, the one or more inputs from a location sensor of the work vehicle, the location sensor being configured to detect a parameter indicative of a location of the work vehicle.

13. The method of claim 9, further comprising:
receiving, with the computing device, the one or more inputs from an operator-controlled input device of the work vehicle.

14. The method of claim 9, wherein the track assembly further comprises a plurality of roller wheels positioned at the lowered position relative to the ground.

15. The method of claim 9, wherein the track assembly further comprises a second idler wheel, the method further comprising:
controlling, with a computing device, an operation of a second actuator such that the second idler wheel is at the lowered position relative to the ground; and
controlling an operation of the first and second actuators to move the first and second idler wheels simultaneously from the lowered position to the raised position when it is determined that the work vehicle has initiated the change in the direction of travel.

16. The method of claim 9, wherein the first actuator corresponds to an electric actuator.
